(19) United States
(12) Patent Application Publication
(10) Pub. No.: US 2012/0041823 A1
(43) Pub. Date: Feb. 16, 2012

(54) METHODS, SYSTEMS, AND COMPUTER READABLE MEDIA FOR PROVIDING AN ELECTRONIC ADVERTISEMENT TO A MOBILE DEVICE

(76) Inventor: Mohammad Khan, San Jose, CA (US)

(21) Appl. No.: 13/211,082

(22) Filed: Aug. 16, 2011

Related U.S. Application Data
(60) Provisional application No. 61/374,243, filed on Aug. 16, 2010.

(51) Int. Cl. G06Q 30/00

(52) U.S. Cl. 705/14.64

(57) ABSTRACT

According to one aspect, the subject matter described herein includes a method for providing an electronic advertisement to a mobile device. The method includes receiving, at an advertisement management server and from a mobile device, a request message for an electronic offer certificate associated with a touch point, the request message including an offer identifier associated with the touch point and a subscriber identifier associated with the mobile device, wherein the offer identifier was obtained by interfacing the mobile device with the touch point. The method also includes identifying, based on the offer identifier, an electronic offer certificate. The method further includes utilizing the subscriber identifier to communicate the identified electronic offer certificate to the mobile device. The method further includes identifying, based on the offer identifier, an electronic advertisement. The method further includes utilizing the subscriber identifier to communicate the identified electronic advertisement to the mobile device.

### RELATED APPLICATIONS

This application claims the benefit of U.S. Provisional Patent Application Ser. No. 61/374,243, filed Aug. 16, 2010; the disclosure of which is incorporated herein by reference in its entirety.

### TECHNICAL FIELD

The subject matter described herein relates to providing an electronic advertisement to a mobile device. More specifically, the subject matter relates to methods, systems, and computer readable media for providing an electronic advertisement to a mobile device.

### BACKGROUND

As mobile device technology has evolved, the mobile device has taken on an ever more prominent role in people's lives. In the consumption context, in particular, modern mobile devices have become a focal point for consumers, enabling them to explore products and services, compare prices, conduct financial transactions, and place and track orders. As a focal point for consumers, mobile devices are an ideal platform for merchants and service providers to communicate marketing information in the form of electronic advertisements.

Existing technologies for providing electronic advertisements to mobile devices, however, have failed to fully appreciate and exploit the advantages offered by the mobile device platform. Many existing technologies for providing electronic advertisements to mobile devices center around algorithms that provide the user with electronic advertisements that are based on a mobile device's web browsing history, prior searches, and geographic location. Such technologies often inundate a mobile device's user with unwanted electronic advertisements that are not related to the user's purchase intent.

Accordingly, a need exists for methods, systems, and computer readable media for providing an electronic advertisement to a mobile device.

### SUMMARY

According to one aspect, the subject matter described herein includes a method for providing an electronic advertisement to a mobile device. The method includes receiving, at an advertisement management server and from a mobile device, a request message for an electronic offer certificate associated with a touch point, the request message including an offer identifier associated with the touch point and a subscriber identifier associated with the mobile device, wherein the offer identifier was obtained by interfacing the mobile device with the touch point. The method also includes identifying, based on the offer identifier, an electronic offer certificate. The method further includes utilizing the subscriber identifier to communicate the identified electronic offer certificate to the mobile device. The method further includes identifying, based on the offer identifier, an electronic advertisement for at least one product or service. The method further includes utilizing the subscriber identifier to communicate the identified electronic advertisement to the mobile device.

According to another aspect, the subject matter described herein includes a system for providing an electronic advertisement to a mobile device. The system includes a communication interface. The system also includes an offer management module. The offer management module is configured to receive, via the communication interface and from a mobile device, a request message for an electronic offer certificate associated with a touch point, the request message including an offer identifier associated with the touch point and a subscriber identifier associated with the mobile device, wherein the offer identifier was obtained by interfacing the mobile device with the touch point. The offer management module is also configured to identify, based on the offer identifier, an electronic offer certificate. The offer management module is further configured to utilize the subscriber identifier to communicate, via the communication interface, the identified electronic offer certificate to the mobile device. The system further includes an advertisement management module. The advertisement management module is configured to identify, based on the offer identifier, an electronic advertisement associated with at least one product or service. The advertisement management module is also configured to utilize the subscriber identifier to communicate, via the communication interface, the identified electronic advertisement to the mobile device.

As used herein, the term “module” refers to software in combination with hardware (such as a processor) and/or firmware for implementing features described herein.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a block diagram of an exemplary system for providing an electronic advertisement to a mobile device in accordance with embodiments of the subject matter described herein;

FIG. 2 is a message flow diagram illustrating an exemplary message sequence for providing an electronic advertisement to a mobile device in accordance with embodiments of the subject matter described herein;

FIGS. 3A and 3B are respectively a first and second portion of a flow chart illustrating an exemplary process for providing an electronic advertisement to a mobile device in accordance with embodiments of the subject matter described herein; and

FIG. 4 is a block diagram illustrating an exemplary advertisement management server for providing an electronic advertisement to a mobile device in accordance with embodiments of the subject matter described herein.

### DETAILED DESCRIPTION

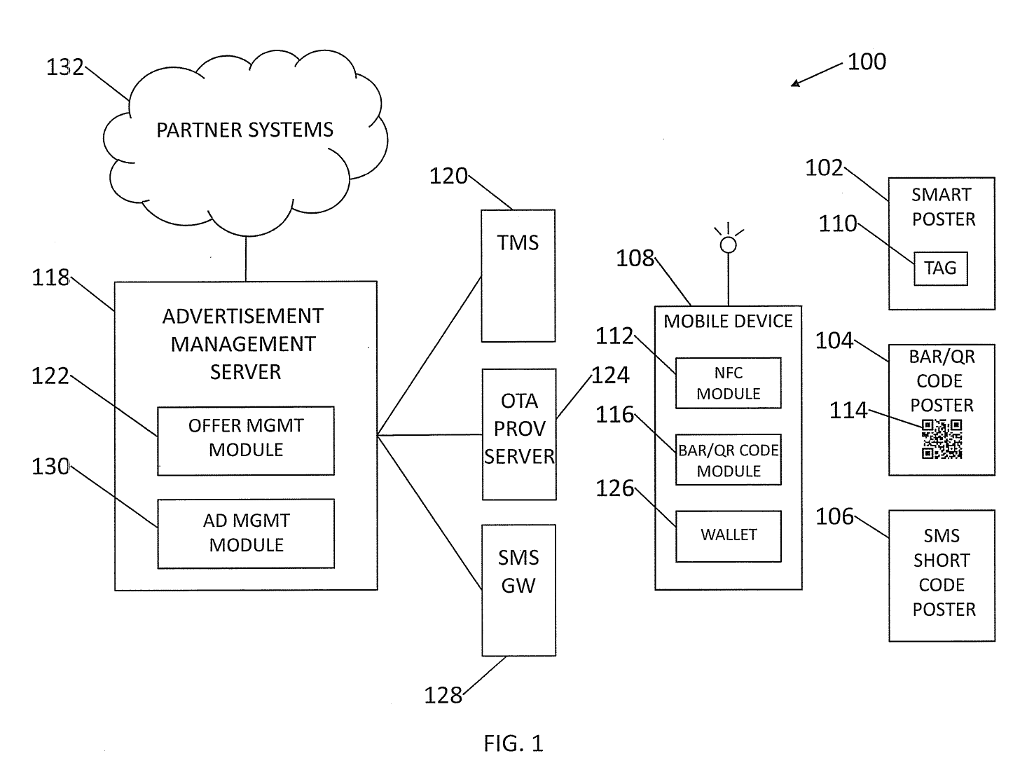

Methods, systems, and computer readable media for providing an electronic advertisement to a mobile device are provided. FIG. 1 is a block diagram of an exemplary system for providing an electronic advertisement to a mobile device in accordance with embodiments of the subject matter described herein. Referring to FIG. 1, system 100 may include one or more touch points 102, 104, and 106 and mobile device 108. Mobile device 108 may be any device capable of interfacing with a touch point and enabling a user of mobile device 108 to express an interest in an offer associated with the interfaced touch point. For example, mobile device 108 may be any device capable of interfacing with one or more of touch points 102, 104, and 106, and enabling a user of mobile device 108 to express an interest in an offer respectively associated with one or more of touch points 102, 104, and 106. A mobile device may include, for example, a tablet computer, a smartphone, or a personal digital assistant. A touch point may be any medium capable of communicating an offer to a user of mobile device 108 and enabling a user of mobile device 108 to express an interest in the communicated offer by interfacing mobile device 108 with the touch point. For example, touch points 102, 104, and 106 may communicate an offer to a user of mobile device 108 and enable the user of mobile device 108 to express an interest in the communicated offer by interfacing mobile device 108 with one or more of touch points 102, 104, and 106.

Exemplary touch points may include a smart poster, such as smart poster 102. Smart poster 102 may include “smart tag” 110, for enabling a near field communications (NEC) enabled device to interface with smart poster 102. For example, mobile device 108 may include NEC module 112 and may utilize NEC module 112 to interface with smart poster 102 via “smart tag” 110 using near field communications. In accordance with exemplary embodiments of the subject matter described herein, a user of mobile device 108 may express an interest in an offer displayed by smart poster 102 by utilizing NEC module 112 to interface with smart poster 102 via “smart tag” 110 and may thereby obtain an offer identifier associated with smart poster 102. Exemplary touch points may also include a bar/quick response (QR) code poster, such as bar/QR code poster 104. Bar/QR code poster 104 may include bar/QR code 114, for enabling a device capable of deriving information stored within bar/QR code 114 to interface with bar/QR code poster 104. For example, mobile device 108 may include bar/QR code module 116 and may utilize bar/QR code module 116 to interface with bar/QR code poster 104 by deriving information stored within bar/QR code 114. For example, mobile device 108 may include a camera (not illustrated), which may be capable of capturing an image of bar/QR code 114, and enabling bar/QR code module 116 to derive information stored within the image of bar/QR code 114. In accordance with exemplary embodiments of the subject matter described herein, a user of mobile device 108 may express an interest in an offer communicated by bar/QR code poster 104 by utilizing bar/QR code module 116 to interface with bar/QR code poster 104 via bar/QR code 114, for example, by utilizing mobile device 108's camera to take a picture of bar/QR code 114 and utilizing bar/QR code module 116 to derive information stored within the picture of bar/QR code 114, and may thereby obtain an offer identifier associated with bar/QR code poster 104.

Exemplary touch points may further include a short message service (SMS) short code poster, such as SMS short code poster 106. SMS short code poster 106 may include a caption (not illustrated) informing a viewer of SMS short code poster 106 of an offer code and a telephone number to which the offer code can be sent, whereby sending the offer code to the designated telephone number constitutes interfacing with SMS short code poster 106. For example, mobile device 108 may be capable of sending SMS messages and a user of mobile device 108 may utilize mobile device 108's SMS capability to “text” an offer code included in a caption of SMS short code poster 106 to a telephone number also included in the caption of SMS short code poster 106, thereby interfacing with SMS short code poster 106. In accordance with exemplary embodiments of the subject matter described herein, a user of mobile device 108 may express an interest in an offer communicated by SMS short code poster 106 by utilizing mobile device 108's SMS capability to “text” such an offer code to such a telephone number and may thereby obtain an offer identifier associated with SMS short code poster 106. A touch point may take the form of a promotional poster and may be located in a high traffic area suitable for advertisement, such as alongside a point of sale, a parking meter, a shelf tag, or a touch point may be part of a print media or Internet advertisement. The touch point may also include a smart poster located outside a merchant location which may be used by the user of the mobile device to “opt-in” to a merchant product campaign. By expressing interest and opting in to the merchant product campaign, the user of the mobile device may agree to receive electronic coupons and/or promotions from the merchant entity or a service provider (e.g., “pushed” electronic coupons and promotions). In an alternate embodiment, the touch point may include a computer screen displaying a web site that includes a web coupon that may be captured by a mobile device camera. In yet another embodiment, a consumer may use a web site interface to push an electronic coupon to his mobile device.

In accordance with embodiments of the subject matter described herein, a user of mobile device 108 may express an interest in an offer communicated by one or more of touch points 102, 104, and 106 and may thereby obtain an offer identifier associated with the interfaced touch point. For example, smart poster 102 may promote an offer for a 10% discount on a soft drink to a user of mobile device 108. The user of mobile device 108 may be interested in the soft drink discount promoted by smart poster 102 and may express an interest in the soft drink discount promoted by smart poster 102 by interfacing mobile device 108 with smart poster 102 and may thereby obtain an offer identifier associated with the soft drink discount. In response to interfacing with one or more of touch points 102, 104, and 106, mobile device 108 may generate a request message for an electronic offer certificate associated with the interfaced touch point. For example, mobile device 108 may generate a request message for an electronic offer certificate for the promoted soft drink discount. The electronic offer certificate request message may further include a subscriber identifier associated with mobile device 108. For example, the request message may include one or more of an international mobile station identifier (IMSI) associated with mobile device 108, a mobile subscriber integrated services digital network number (MSISDN) associated with mobile device 108, an Internet protocol (IP) address associated with mobile device 108, and a telephone number associated with mobile device 108. Mobile device 108 may communicate such an electronic offer certificate request message to advertisement management server (AMS) 118. For example, mobile device 108 may be associated with a trigger management server (TMS), such as TMS 120, and may communicate the electronic offer certificate request message containing the offer identifier and the subscriber identifier to TMS 120. TMS 120 may serve as a central contact point for electronic offer certificate request messages from mobile devices with which it is associated. For example, TMS 120 may serve as a central contact point for electronic offer certificate request messages from mobile device 108. In response to receiving the electronic offer certificate request message, TMS 120 may identify an AMS associated with the offer identifier contained in the electronic offer certificate request message and may forward the electronic offer certificate request message to the identified AMS. For example, TMS 120 may identify AMS 118 as being associated with the offer identifier contained in the electronic offer certificate request message generated by mobile device 108 (e.g., the soft drink discount promotion) and may forward the electronic offer certificate request message to AMS 118.

AMS 118 may include offer management module 122. Offer management module 122 may be configured to receive the electronic offer certificate request message from mobile device 108 and identify, based on the offer identifier contained in the electronic offer certificate request message, an electronic offer certificate (e.g., an electronic offer certificate for obtaining the promoted soft drink discount). Offer management module 122 may further be configured to utilize the subscriber identifier associated with mobile device 108 and contained in the electronic offer certificate request message to communicate the identified electronic offer certificate to mobile device 108. For example, system 100 may include over-the-air (OTA) provisioning server 124. In one embodiment, offer management module 122 may communicate the electronic offer certificate to OTA provisioning server 124. OTA provisioning server 124 may then provision a module associated with mobile device 108 with the identified electronic offer certificate. For example, mobile device 108 may be associated with “wallet” module 126. “Wallet” module 126 may be configured to store various electronic offer certificates for subsequent redemption by a user of mobile device 108. In accordance with embodiments of the subject matter described herein, OTA provisioning server 124 may provision “wallet” module 126 with the identified electronic offer certificate for subsequent redemption by a user of mobile device 108. For example, OTA provisioning server 124 may provision “wallet” module 126 with an electronic offer certificate for the promoted soft drink discount, which a user of mobile device 108 may subsequently redeem, for example, when purchasing the promoted soft drink. In lieu of or in addition to OTA provisioning server 124, system 100 may include SMS gateway 128. In one embodiment, offer management module 122 may communicate the electronic offer certificate to SMS gateway 128. SMS gateway 128 may then provision a module associated with mobile device 108 with the identified electronic offer certificate by sending an encoded SMS message to mobile device 108. For example, in accordance with embodiments of the subject matter described herein, SMS gateway 128 may provision “wallet” module 126 with the identified electronic offer certificate for subsequent redemption by a user of mobile device 108.

AMS 118 may also include advertisement management module 130. Advertisement management module 130 may be configured to identify, based on the offer identifier contained in the electronic offer certificate request message, an electronic advertisement. In one embodiment, an electronic advertisement may provide information pertaining to a good, product, or service. For example, in addition to the soft drink discount promotion, smart poster 102 may include promotional material for a new sports utility vehicle (SUV). In interfacing mobile device 108 with smart poster 102, mobile device 108's user may have consented to receiving electronic advertisements (i.e., in addition to promoting one or more products or services a touch point may be used to induce or compel a mobile device user to provide identifying information that can be used to communicate electronic advertisements and/or to consent to receiving such electronic advertisements). The electronic advertisement identified by advertisement management module 130 may be related to the offer identifier, for example, the electronic advertisement may be related to the discounted soft drink product line or the co-promoted SUV, or the identified electronic advertisement may be unrelated to the offer identifier, for example, the identified electronic advertisement may be for another product or service which advertisement management module 130 is able to determine might interest a user of mobile device 108. For example, advertisement management module 130 may be able to identify products or services that might interest a user of mobile device 108 by reviewing the electronic offer history of mobile device 108, determining the current geographic location of mobile device 108, and/or reviewing past offer redemptions and/or purchases made using mobile device 108 and/or wallet module 126. The identified electronic advertisement may be provided by one or more partner systems 132. For example, partner systems 132 may include one or more product manufacturers, service providers, wholesalers, retailers, marketing agencies, promotion firms, advertisement aggregators, and/or coupon aggregators. In one embodiment, the electronic advertisement may be identified based on a location of the interfaced touch point from which the offer identifier was obtained. For example, smart poster 102 may be located in a particular geographic location, the offer identifier associated with smart poster 102 may be associated with the geographic location in which smart poster 102 is located, and advertisement management module 130 may identify an electronic advertisement that is particularly relevant to that geographic location, for example, a car dealership which sells the promoted SUV in the geographic region. Utilizing such geographic information may be particularly advantageous because it is known, from mobile device 108's interfacing with smart poster 102, that a user of mobile device 108 is contemporaneously located in the geographic region associated with smart poster 102.

In one embodiment, the identified electronic advertisement may include a second offer certificate associated with the electronic advertisement. For example, if the first offer certificate is for a discounted soft drink, the electronic advertisement may be for another food or beverage product produced by the soft drink manufacturer and may include a second electronic offer certificate that can be redeemed by a user of mobile device 108 when purchasing the discounted soft drink. Similarly, the identified electronic advertisement may include a second offer identifier. For example, if the first offer is for a discounted soft drink, the electronic advertisement may be for another food or beverage product produced by the soft drink manufacturer and may include a second offer identifier that becomes available to mobile device 108's user when the first electronic offer certificate is redeemed, providing an opportunity for mobile device 108's user to obtain a second electronic offer certificate to be redeemed as part of a subsequent purchase.

In accordance with embodiments of the subject matter described herein, advertisement management module 130 may query an advertisement policy database (not illustrated in FIG. 1) to obtain an advertisement policy associated with the offer identifier contained in the electronic offer certificate request message and may identify the electronic advertisement based on the obtained advertisement policy. For example, advertisement module 130 may query an advertisement policy database to obtain an advertisement policy associated with the offer identifier obtained by mobile device 108 in interfacing with smart poster 102. The obtained advertisement policy may specify how the electronic advertisement should be displayed. For example, the obtained advertisement policy may specify whether the electronic advertisement is to be provided to mobile device 108 immediately, based on a user of mobile device 108's preference for viewing electronic advertisements, or based on a user associated with mobile device 108's interaction with the obtained electronic offer certificate (e.g., the electronic advertisement is to be displayed when a user of mobile device 108 redeems the electronic offer certificate). In one embodiment, the obtained advertisement policy may specify multiple possible electronic advertisements and may identify an electronic advertisement from among the possible electronic advertisements by conducting an auction amongst the providers of the electronic advertisements. For example, the obtained advertisement policy may specify multiple electronic advertisements for various car dealerships selling the promoted SUV and may conduct an auction amongst the car dealerships to identify an electronic advertisement for delivery to mobile device 108, the identified electronic advertisement corresponding to the highest bid in the auction.

In one embodiment, advertisement management module 130 may query an advertisement policy database to obtain an advertisement policy associated with the subscriber identifier contained in the electronic offer certificate request message and may identify the electronic advertisement based on the obtained advertisement policy. For example, advertisement module 130 may query an advertisement policy database to obtain an advertisement policy associated with the subscriber identifier contained in the electronic offer certificate request message. The obtained advertisement policy may specify that the electronic advertisement should be identified based on an electronic offer history associated with the subscriber identifier and/or an electronic offer certificate history associated with the subscriber identifier. For example, the obtained advertisement policy may specify that the electronic advertisement should be identified based on an electronic offer history associated with a subscriber identifier that is associated with mobile device 108 and/or an electronic offer certificate history associated with a subscriber identifier that is associated with mobile device 108. In one embodiment, the electronic offer certificate history may also include location information of touch points previously interfaced by a subscriber's mobile device. Utilizing the subscriber identifier in identifying an electronic advertisement increases the probability that the identified electronic advertisement will correspond to a product or service that will interest a user associated with the subscriber identifier and/or the mobile device. For example, if an electronic offer history associated with the subscriber identifier indicates that there is a substantial history of electronic offers for soft drink discounts, advertisement management module 130 may identify an electronic advertisement associated with soft drinks (e.g., an advertisement to obtain a new soft drink discount in the future or an advertisement for a product or service that is often desired by people who purchase soft drinks). Similarly, if an electronic offer certificate history associated with the subscriber identifier indicates that there is a substantial history of electronic offer certificates for soft drinks, advertisement management module 130 may identify an electronic advertisement associated with soft drinks. It should be appreciated that as the historical record associated with a subscriber identifier increases the electronic advertisement(s) identified by advertisement management module 130 have an increasingly greater chance of interesting a user of mobile device 108. Thus, by utilizing the historical record associated with a subscriber identifier, advertisement management module 130 may be configured to provide an advertisement that is customized or targeted to the associated subscriber user.

In one embodiment, the electronic advertisement policy may specify that an electronic offer history associated with a subscriber identifier should be compared against an electronic offer certificate history associated with the subscriber identifier to calculate a yield metric for a particular electronic advertisement category. In such an embodiment, advertisement management module 130 may be configured to identify the electronic advertisement based on the yield metric. For example, advertisement management module 130 may compare an electronic offer history associated with a subscriber identifier against an electronic offer certificate history associated with the subscriber identifier and determine that a user associated with mobile device 108 frequently requests electronic offer certificates for electronic offers related to a particular product category (e.g., soft drinks). Such a “high yield” determination may indicate that the user is likely to be interested in future offers related to that same product category (e.g., soft drinks) or to a product category that other users who are interested in that product category have expressed an interest in (e.g., potato chips). Conversely, a “low yield” determination for a product or service category (i.e., a comparison between an electronic offer history and an electronic offer certificate history that indicates that a user rarely obtains electronic offer certificates related to the product or service category) may indicate that future electronic advertisements should not be directed to advertisements associated with the product or service category.

Having identified an electronic advertisement, advertisement management module 130 may utilize the subscriber identifier contained in the electronic offer certificate request message to communicate the identified electronic advertisement to mobile device 108. It should be appreciated that the subject matter described herein creates a new paradigm for providing electronic advertisements to a mobile device. From the perspective of a user of mobile device 108, the subject matter described herein provides electronic advertisements that are relevant to the user's interests, namely purchase intent, and presents the user with electronic advertisements that are a product of the user's action (e.g., interfacing mobile device 108 with smart poster 102), mitigating the overwhelming effect created by traditional approaches to providing electronic advertisements to a mobile device that often inundate the user with unwanted information. From the perspective of advertisers, providing electronic advertisements to a mobile device, such as mobile device 108, in accordance with embodiments of the subject matter described herein increases return on investment. Moreover, from the perspective of promoters, the subject matter described herein creates a new opportunity for revenue. For example, promoters can utilize touch points that promote coupons and or offers to entice mobile device users to interface with the touch points and thereby consent to future electronic advertisements. Promoters, in turn, may benefit from various compensation agreements with the providers of the electronic advertisements.

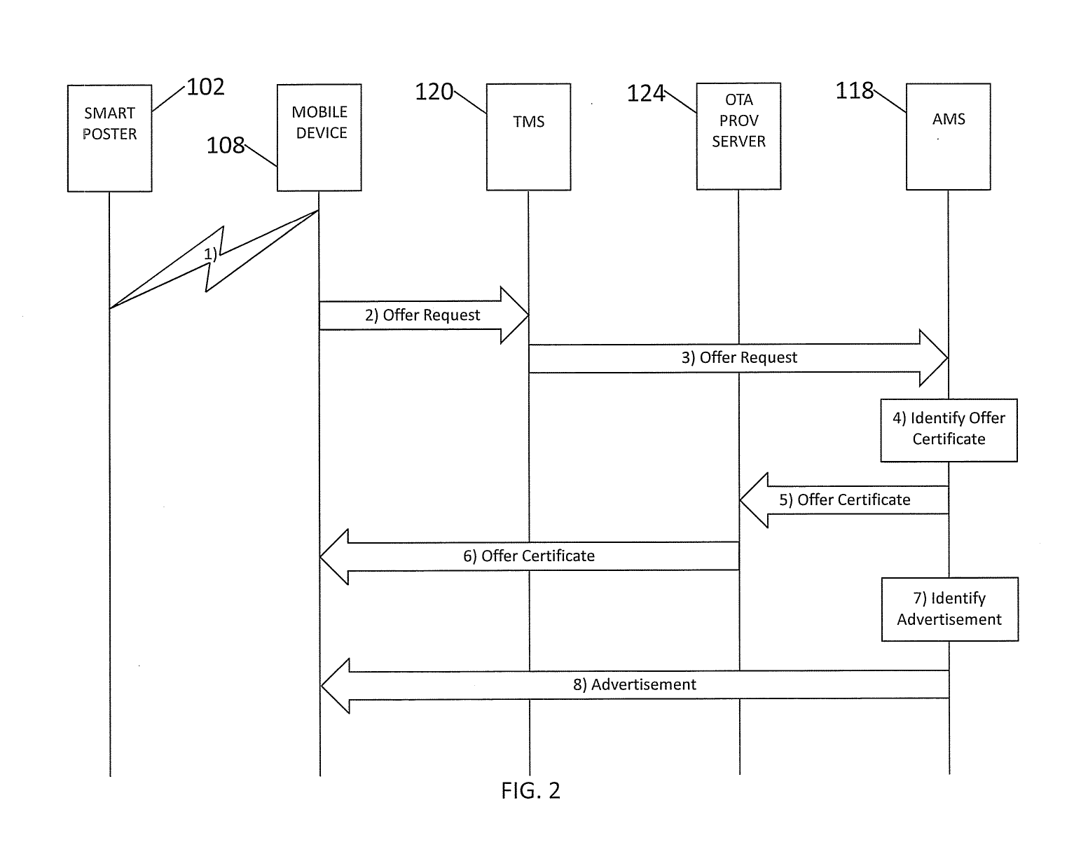

FIG. 2 is a message flow diagram illustrating an exemplary message sequence for providing an electronic advertisement to a mobile device in accordance with embodiments of the subject matter described herein. Referring to FIG. 2, at step 1, a user of mobile device 108 may express an interest in an offer promoted by smart poster 102 by interfacing mobile device 108 with smart poster 102, thereby obtaining an offer identifier associated with smart poster 102. For example, smart poster 102 may promote a new SUV and may contain an offer identifier for a soft drink discount. A user of mobile device 108 may interface mobile device 108 with smart poster 102, thereby obtaining the offer identifier for the soft drink discount. At step 2, mobile device 108 may generate, and communicate to TMS 120, an electronic offer certificate request message containing the offer identifier associated with smart poster 102 and a subscriber identifier associated with mobile device 108. For example, mobile device 108 may generate, and communicate to TMS 120, an electronic offer certificate request message for the soft drink discount which may contain the offer identifier for the soft drink discount and a subscriber identifier associated with mobile device 108. At step 3, TMS 120 may receive the electronic offer certificate request message, may identify AMS 118 as being associated with the offer identifier contained within the electronic offer certificate request message, and may forward the electronic offer certificate request message to AMS 118. For example, TMS 120 may receive the electronic offer certificate request message for the soft drink discount, may identify AMS 118 as being associated with the offer identifier for the soft drink discount, and may forward the electronic offer certificate request message to AMS 118. At step 4, AMS 118 may identify, based on the offer identifier contained within the electronic offer certificate request message, an electronic offer certificate. For example, AMS 118 may identify, based on the offer identifier for the soft drink discount, an electronic offer certificate for the soft drink discount. At step 5, AMS 118 may utilize the subscriber identifier contained within the electronic offer certificate request message to communicate the identified electronic offer certificate to an OTA provisioning server associated with mobile device 108, such as OTA provisioning server 124. For example, AMS 118 may utilize the subscriber identifier contained within the electronic offer certificate request message for the soft drink discount to communicate the identified electronic offer certificate request message to OTA provisioning server 124. At step 6, OTA provisioning server 124 may provision mobile device 108 with the identified electronic offer certificate. For example, OTA provisioning server 124 may provision “wallet” module 126 of mobile device 108 with the soft drink discount electronic offer certificate. At step 7, AMS 118 may identify an electronic advertisement associated with the offer identifier contained within the electronic offer certificate request message. For example, AMS 118 may identify an electronic advertisement for the promoted SUV that is associated with the offer identifier contained within the electronic offer certificate request message for the soft drink discount. At step 8, AMS 118 may utilize the subscriber identifier contained within the electronic offer certificate request message to communicate the identified electronic advertisement to mobile device 108. For example, AMS 118 may utilize the subscriber identifier associated with mobile device 108 and contained within the electronic offer certificate request message for the soft drink discount to communicate the SUV electronic advertisement to mobile device 108. In an alternative embodiment (not illustrated), AMS 118 may utilize the subscriber identifier contained within the electronic offer certificate request message to communicate the identified electronic advertisement to mobile device 108 via OTA provisioning server 124. For example, AMS 118 may utilize the subscriber identifier associated with mobile device 108 and contained within the electronic offer certificate request message for the soft drink discount to communicate the SUV electronic advertisement to OTA provisioning server 124, which may forward the SUV electronic advertisement to mobile device 108. It is appreciated that the above described steps are only exemplary and that the steps may be performed in various orders or combined. For example, AMS 118 may identify the electronic advertisement before identifying the electronic offer certificate, or contemporaneous with identifying the electronic offer certificate. Similarly, the identified electronic advertisement may be communicated before the identified electronic offer certificate or contemporaneous with the electronic offer certificate.

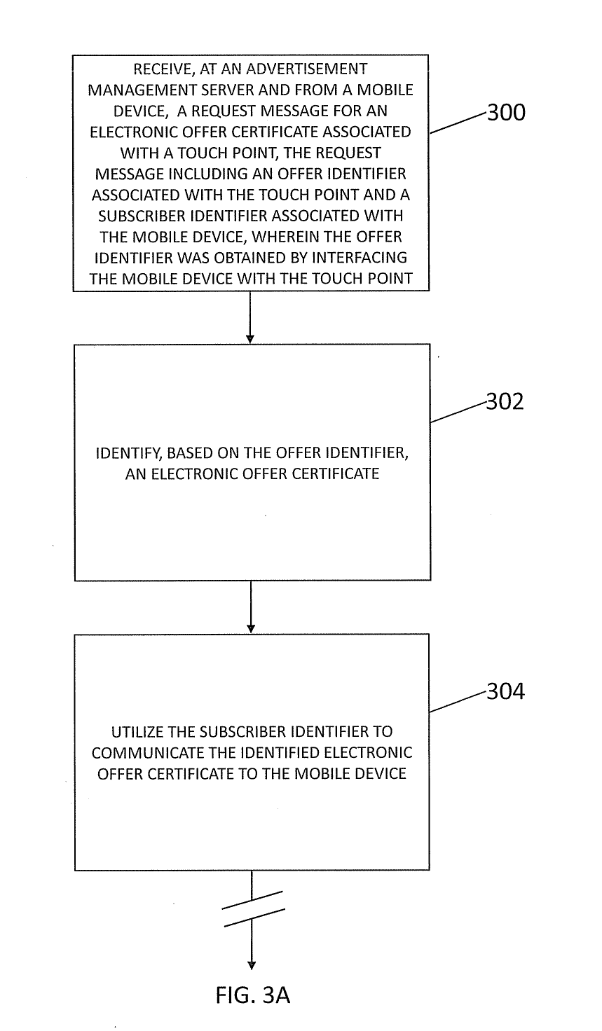

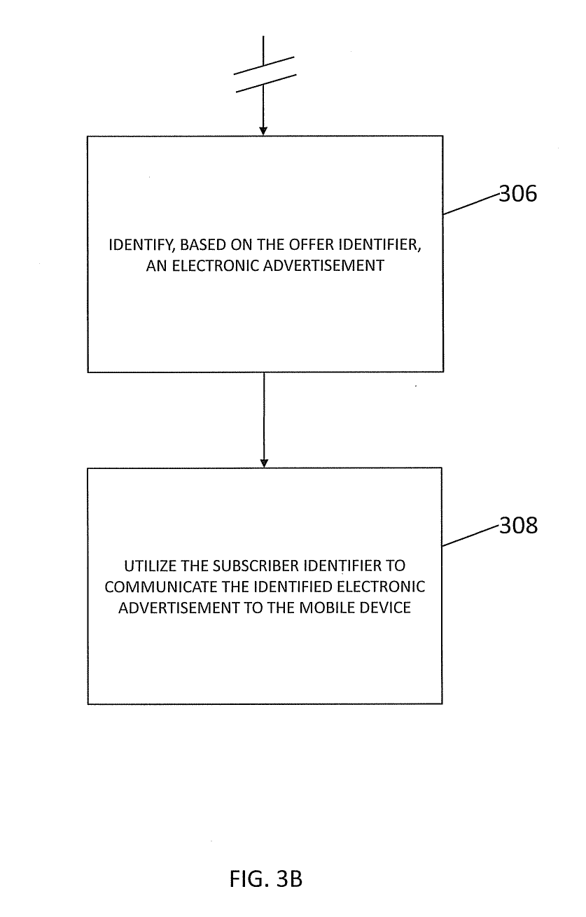

FIGS. 3A and 3B are respectively a first and second portion of a flow chart illustrating an exemplary process for providing an electronic advertisement to a mobile device in accordance with embodiments of the subject matter described herein. Referring to FIG. 3A, in step 300, a request message for an electronic offer certificate associated with a touch point is received at an advertisement management server and from a mobile device, the request message including an offer identifier associated with the touch point and a subscriber identifier associated with the mobile device, wherein the offer identifier was obtained by interfacing the mobile device with the touch point. For example, a request message for the soft drink discount electronic offer certificate associated with smart poster 102 may be received at AMS 118 from mobile device 108, the request message may include the soft drink discount offer identifier associated with smart poster 102 and a subscriber identifier associated with mobile device 108, and the soft drink discount may have been obtained by interfacing mobile device 108 with smart poster 102. In step 302, an electronic offer certificate is identified based on the offer identifier. For example, AMS 118 may identify the soft drink discount electronic offer certificate based on the soft drink discount offer identifier. In step 304, the subscriber identifier is utilized to communicate the identified electronic offer certificate to the mobile device. For example, AMS 118 may utilize the subscriber identifier associated with mobile device 108 to communicate the soft drink discount electronic offer certificate to mobile device 108. Referring to FIG. 3B, in step 306, an electronic advertisement is identified based on the offer identifier. For example, AMS 118 may identify the SUV electronic advertisement based on the soft drink discount offer identifier. In step 308, the subscriber identifier is utilized to communicate the identified electronic advertisement to the mobile device. For example, AMS 118 may utilize the subscriber identifier associated with mobile device 108 to communicate the SUV electronic advertisement to mobile device 108.

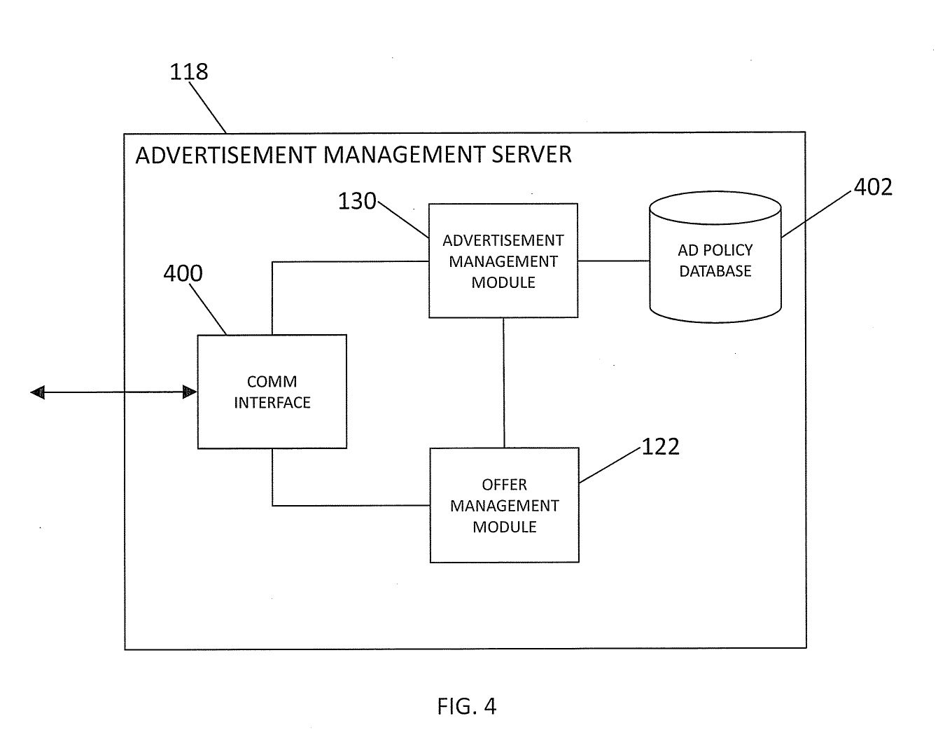

FIG. 4 is a block diagram illustrating an exemplary advertisement management server for providing an electronic advertisement to a mobile device in accordance with embodiments of the subject matter described herein. Referring to FIG. 4, AMS 118 may include communication interface 400. Communication interface 400 may be any communication interface suitable for sending to and receiving messages from a mobile device, such as mobile device 108. For example, communication interface 400 may be an Ethernet card. AMS 118 may also include offer management module 122. Offer management module 122 may be configured to receive, via communication interface 400 and from a mobile device, a request message for an electronic offer certificate associated with a touch point, the request message including an offer identifier associated with the touch point and a subscriber identifier associated with the mobile device, wherein the offer identifier was obtained by interfacing the mobile device with the touch point. For example, offer management module 122 may be configured to receive, via communication interface 400 and from mobile device 108, the soft drink discount electronic offer certificate request message for the soft drink discount offer certificate associated with smart poster 102, the soft drink discount electronic offer certificate request message may include the soft drink discount offer identifier associated with smart poster 102 and a subscriber identifier associated with mobile device 108, and the soft drink discount offer identifier may have been obtained by interfacing mobile device 108 with smart poster 102. Offer management module 122 may also be configured to identify, based on the offer identifier, an electronic offer certificate. For example, offer management module 122 may be configured to identify, based on the soft drink discount offer identifier, the soft drink discount electronic offer certificate. Offer management module 122 may further be configured to utilize the subscriber identifier to communicate, via communication interface 400, the identified electronic offer certificate to the mobile device. For example, offer management module 122 may be configured to utilize the subscriber identifier associated with mobile device 108 to communicate, via communication interface 400, the soft drink discount electronic offer certificate to mobile device 108. AMS 118 may also include advertisement management module 130. Advertisement management module 130 may be configured to identify, based on the offer identifier, an electronic advertisement. For example, advertisement management module 130 may be configured to identify, based on the soft drink discount offer identifier, the SUV electronic advertisement. In one embodiment, AMS 118 may include advertisement policy database 402, and advertisement management module 130 may be operative to communicate with advertisement policy database 402. Advertisement policy database 402 may include an advertisement policy associated with the offer identifier, and advertisement management module 130 may be configured to identify the electronic advertisement based on the advertisement policy associated with the offer identifier. For example, advertisement policy database 402 may include an advertisement policy associated with the soft drink discount offer identifier that may specify that the identified electronic advertisement (e.g., the SUV electronic advertisement) should be displayed when the soft drink discount electronic offer certificate is redeemed by a user of mobile device 108. Advertisement management module 130 may also be configured to utilize the subscriber identifier to communicate, via communication interface 400, the identified electronic advertisement to the mobile device. For example, advertisement management module 130 may be configured to utilize the subscriber identifier associated with mobile device 108 to communicate, via communication interface 400, the SUV electronic advertisement to mobile device 108.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing an electronic advertisement to a mobile device, the method comprising:
receiving, at an advertisement management server and from a mobile device, a request message for a first electronic offer certificate associated with a touch point, the request message including a first offer identifier obtained by interfacing the mobile device with the touch point and a subscriber identifier associated with the mobile device;
identifying, based on the first offer identifier, the first electronic offer certificate;
utilizing the subscriber identifier to communicate the identified first electronic offer certificate to the mobile device;
identifying, based on the first offer identifier, an electronic advertisement for at least one product or service; and
utilizing the subscriber identifier to communicate the identified electronic advertisement to the mobile device.

2. The method of claim 1 wherein the electronic advertisement includes at least one of a second offer identifier associated with the electronic advertisement and a second electronic offer certificate associated with the electronic advertisement.

3. The method of claim 1 wherein identifying the electronic advertisement includes: determining, based on the first offer identifier, a location of the touch point; and identifying the electronic advertisement based on the determined location of the touch point.

4. The method of claim 1 wherein identifying the electronic advertisement includes querying an advertisement policy database to obtain an advertisement policy associated with the first offer identifier and identifying the electronic advertisement based on the obtained advertisement policy.

5. The method of claim 4 wherein the obtained advertisement policy specifies whether the electronic advertisement is to be provided to the mobile device immediately, based on a user associated with the mobile device's preference to view the electronic advertisement, or based on a user associated with the mobile device's interaction with the first electronic offer certificate.

6. The method of claim 4 wherein the obtained advertisement policy specifies a plurality of possible electronic advertisements and wherein identifying the electronic advertisement includes conducting an auction among providers of the possible electronic advertisements and selecting, for communication to the mobile device, the electronic advertisement which receives the highest bid.

7. The method of claim 1 wherein identifying the electronic advertisement includes querying an advertisement policy database to obtain an advertisement policy associated with the subscriber identifier and identifying the electronic advertisement based on the obtained advertisement policy.

8. The method of claim 7 wherein the obtained advertisement policy specifies that the electronic advertisement should be identified based on at least one of an electronic offer history associated with the subscriber identifier and an electronic offer certificate history associated with the subscriber identifier.

9. The method of claim 7 wherein the obtained advertisement policy specifies that the electronic advertisement should be identified based on a yield metric for a particular electronic advertisement category, wherein the yield metric is calculated by comparing an electronic offer history associated with the subscriber identifier against an electronic offer certificate history associated with the subscriber identifier.

10. The method of claim 1 wherein the touch point comprises one of a smart poster, a barcode poster, a quick response (QR) code poster, a short message service (SMS) short code poster, a point of sale device, a parking meter, a shelf tag, a print media advertisement, and an Internet advertisement.

11. The method of claim 1 wherein the mobile device is a near field communications (NFC) enabled device, the touch point includes an NFC tag associated with the first electronic offer certificate, and the first offer identifier is obtained by interfacing the mobile device with the NFC tag associated with the first electronic offer certificate.

12. The method of claim 1 wherein the mobile device includes a camera, the mobile device is configured to derive information encoded in a barcode or quick response (QR) code captured by the camera, the touch point includes a barcode or QR code associated with the first electronic offer certificate, and the first offer identifier is obtained by the mobile device deriving the offer identifier from the barcode or QR code associated with the electronic offer certificate and captured by the camera.

13. The method of claim 1 wherein the subscriber identifier includes at least one of an international mobile station identifier (IMSI) associated with the mobile device, a mobile subscriber integrated services digital network number (MSISDN) associated with the mobile device, an Internet protocol (IP) address associated with the mobile device, and a telephone number associated with the mobile device.

14. A system for providing an electronic advertisement to a mobile device, the system comprising:
a communication interface;
an offer management module configured to:
receive, via the communication interface and from a mobile device, a request message for a first electronic offer certificate associated with a touch point, the request message including a first offer identifier obtained by interfacing the mobile device with the touch point and a subscriber identifier associated with the mobile device;
identify, based on the first offer identifier, the first electronic offer certificate for at least one product or service; and
utilize the subscriber identifier to communicate, via the communication interface, the identified first electronic offer certificate to the mobile device; and
an advertisement management module configured to:
identify, based on the first offer identifier, an electronic advertisement; and
utilize the subscriber identifier to communicate, via the communication interface, the identified electronic advertisement to the mobile device.

15. The system of claim 14 wherein the electronic advertisement includes at least one of a second offer identifier associated with the electronic advertisement and a second electronic offer certificate associated with the electronic advertisement.

16. The system of claim 14 wherein the advertisement management module is configured to: determine, based on the first offer identifier, a location of the touch point; and identify the electronic advertisement based on the determined location of the touch point.

17. The system of claim 14 wherein the advertisement management module is configured to query an advertisement policy database to obtain an advertisement policy associated with the first offer identifier and identify the electronic advertisement based on the obtained advertisement policy.

18. The system of claim 17 wherein the obtained advertisement policy specifies whether the electronic advertisement is to be provided to the mobile device immediately, based on a user associated with the mobile device's preference to view the electronic advertisement, or based on a user associated with the mobile device's interaction with the first electronic offer certificate.

19. The system of claim 17 wherein the obtained advertisement policy specifies a plurality of possible electronic advertisements and wherein the advertisement management module is configured to conduct an auction among providers of the possible electronic advertisements and select, for communication to the mobile device, the electronic advertisement which receives the highest bid.

20. The system of claim 14 wherein the advertisement management module is configured to query an advertisement policy database to obtain an advertisement policy associated with the subscriber identifier and identify the electronic advertisement based on the obtained advertisement policy.

21. The system of claim 20 wherein the obtained advertisement policy specifies that the electronic advertisement should be identified based on at least one of an electronic offer history associated with the subscriber identifier and an electronic offer certificate history associated with the subscriber identifier.

22. The system of claim 20 wherein the obtained advertisement policy specifies that the electronic advertisement should be identified based on a yield metric for a particular electronic advertisement category, wherein the yield metric is calculated by comparing an electronic offer history associated with the subscriber identifier against an electronic offer certificate history associated with the subscriber identifier.

23. The system of claim 14 wherein the touch point comprises one of a smart poster, a barcode poster, a quick response (QR) code poster, a short message service (SMS) short code poster, a point of sale device, a parking meter, a shelf tag, a print media advertisement, and an Internet advertisement.

24. The system of claim 14 wherein the mobile device is a near field communications (NFC) enabled device, the touch point includes an NFC tag associated with the first electronic offer certificate, and the first offer identifier was obtained by interfacing the mobile device with the NFC tag associated with the first electronic offer certificate.

25. The system of claim 14 wherein the mobile device includes a camera, the mobile device is configured to derive information encoded in a barcode or quick response (QR) code captured by the camera, the touch point includes a barcode or QR code associated with the first electronic offer certificate, and the first offer identifier is obtained by the mobile device deriving the offer identifier from the barcode or QR code associated with the electronic offer certificate and captured by the camera.

26. The system of claim 14 wherein the subscriber identifier includes at least one of an international mobile station identifier (IMSI) associated with the mobile device, a mobile subscriber integrated services digital network number (MSISDN) associated with the mobile device, an Internet protocol (IP) address associated with the mobile device, and a telephone number associated with the mobile device.

27. A non-transitory computer readable medium comprising computer executable instructions that when executed by a processor of a computer control the computer to perform steps comprising:
receiving, at an advertisement management server and from a mobile device, a request message for a first electronic offer certificate associated with a touch point, the request message including a first offer identifier obtained by interfacing the mobile device with the touch point and a subscriber identifier associated with the mobile device;
identifying, based on the first offer identifier, the first electronic offer certificate;
utilizing the subscriber identifier to communicate the identified first electronic offer certificate to the mobile device;
identifying, based on the first offer identifier, an electronic advertisement for at least one product or service; and
utilizing the subscriber identifier to communicate the identified electronic advertisement to the mobile device.
